(19) United States
(12) Patent Application Publication
(10) Pub. No.: US 2006/0194145 A1
(43) Pub. Date: Aug. 31, 2006

(54) Photogenerated polyelectrolyte bilayers from an aqueous-processible photoresist

(76) Inventors: Darrell Irvine, Arlington, MA (US); Junsang Doh, Cambridge, MA (US)

Correspondence Address: Valarie B. Rosen;Choate, Hall & Stewart, LLP, Two International Place, Boston, MA, 02110, US

(21) Appl. No.: 11/171,011

(22) Filed: Jun. 30, 2005

Related U.S. Application Data
(60) Provisional application No. 60/584,044, filed on Jun. 30, 2004.

(51) Int. Cl. G03C 1/76

(52) U.S. Cl. 430/270.1

(57) ABSTRACT

A terpolymer of a hydrophobic polymer, for example, methyl methacrylate, a hydrophilic polymer, for example, poly(ethylene glycol) methacrylate, and a polymer having a sidegroup that is photocleavable to produce a carboxyl side chain, for example, o-nitrobenzyl methacrylate, is employed as a photoresist.

This application claims the priority of U.S. Provisional Application No. 60/584,044, filed Jun. 30, 2004, the entire contents of which are incorporated herein by reference.

### FIELD OF THE INVENTION

This invention pertains to resists for photolithography, and, more specifically, to aqueous-processible photoresists.

### BACKGROUND OF THE INVENTION

Surface immobilization of proteins in micron-scale patterns has importance for bioengineering, biosensors, and fundamental studies of cell biology,¹⁻⁴ but is made challenging by the fragile structure of proteins and their propensity for nonspecific binding to surfaces. Several techniques such as photolithography,^{6,7} soft lithography,^{3,8,9} photo-chemical methods¹⁰, and dip-pen nanolithography¹¹ have been developed, which have primarily focused on the immobilization of one protein in defined regions surrounded by a ‘background’ which lacks protein (and may be additionally resistant to the adsorption of other proteins from solution). However, to mimic complex cell-cell and cellextracellular matrix interactions, patterned surfaces comprised of multiple functional protein regions on cellular and sub-cellular length scales would be useful. Few methods have been reported which allow patterning of multiple proteins on surfaces, and these may have limitations in spatial resolution, or in patterning fragile proteins that cannot withstand dehydration^{14,15} or exposure to organic solvents.¹⁶ The application of photolithography to patterning of biomacromolecules is limited by the harsh processing conditions required: typically, photoresists (PRs) are developed with organic solvents or strong bases, which can denature proteins and destroy their activity. ^{1,2,6,16} Thus, it is desirable to develop photolithographic techniques that may be used to pattern proteins onto defined regions of a surface without exposing them to irradiation, organic solvents, or dehydration.

### SUMMARY OF THE INVENTION

In one aspect, the invention is a photoresist material including a terpolymer of methyl methacrylate, poly(ethylene glycol) methacrylate, and o-nitrobenzyl methacrylate. In another aspect, the invention is a photoresist material including a photocleavable polymer. The photocleaved polymer may be substantially insoluble in aqueous solutions at pH 6 but soluble in aqueous solutions having a pH, greater than 6, for example 6.5 or greater.

In another aspect, the invention is a photoresist material including a terpolymer of a hydrophobic monomer, a hydrophilic monomer, and a monomer having a side group of 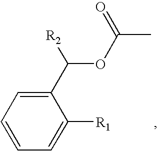
wherein R₁ is H or NO₂, and wherein R₂, is selected from benzyl, benzoyl, alkyl, alkenyl, hydrogen, aryl, and cycloalkyl. The monomer having a side group may be photocleavable to a carbonyl group. At least 30%, 35%, 40%, 45%, or 50%, of the mers of the terpolymer may correspond to the hydrophobic monomer. At most 30%, 25%, 20%, 15%, or 10% of the mers of the terpolymer may correspond to the hydrophilic monomer. The hydrophobic monomer may be selected from methyl methacrylate, ethyl methacrylate, n-butyl methacrylate, n-decyl methacrylate, 2-ethylhexyl methacrylate, N-(n-octadecyl)acrylamide, n-tert-octylacrylamide, stearyl acrylate, stearyl methacrylate, and vinyl stearate. They hydrophilic monomer may be selected from hydroxyethylmethacrylate, hydroxyethyl acrylate, 4-hydroxybutyl methacrylate, N-(2-hydroxypropyl)methacrylamide, n-methylmethacrylamide, acrylamide, poly(ethylene glycol) monomethyl ether methacrylates, poly(ethylene glycol) methacrylate, poly(ethylene glycol) methacrylates, and n-vinyl-2-pyrrolidone. The poly(ethylene glycol) chain may be 3-9 mers long, for example, 6 mers long. The monomer having the side group may experience photocleavage upon exposure to at least about 1350 mJ/cm² of UV radiation, for example, at least 2025mJ/cm² of UV radiation. The terpolymer may be functionalized with streptavidin, biotin, carboxyl groups, cucurbituril, cyclodextrin, diaminoalkyl groups, alkyl groups, polyethylene glycol, or a macrocyclic host group.

In another aspect, the invention is a method of patterning a material. The method includes providing a substrate having an electropositive surface, depositing a photoresist having a photocleavable group over the electropositive surface to coat the surface with the photoresist, exposing a first portion of the coated substrate to radiation at a wavelength and for a time sufficient to photocleave the photocleavable group, and rinsing the substrate in an aqueous solution, for example, having a pH between 6 and 8, in which the photocleaved portion of the photoresist is substantially more soluble than the photoresist, thereby removing a first portion of the photoresist to form a patterned surface.

The method may further include exposing a second portion of the coated substrate to radiation at a wavelength and for a time sufficient to photocleave the photocleavable group of the photoresist, depositing the material over the patterned surface, and rinsing the substrate in the solution, whereby a second portion of the photoresist is removed to form a surface on which the material is patterned. The second portion of the coated substrate may include the remaining photoresist-coated surface of the substrate. The material may be a protein, a biomolecule, a nucleic acid, a nanoparticle, or a quantum dot. The pattern may include a feature having at least one in-plane width of 1 micrometer or less, for example 0.1 micrometer or less. Providing a substrate may include depositing an electrolyte, for example a polyelectrolyte or a self-assembled monolayer including amine-terminated molecules, over a surface of the substrate. The polyelectrolytes may include poly(allylamine)hydrochloride (PAH), polylysine, poly(ethyleneimine), poly(diethylaminoethyl methacrylate), poly(2-aminoethyl methacrylate), or chitosan. A quantity of photoresist may remain on the surface of the substrate following rinsing. The substrate may include a metal, a ceramic, a semiconductor, or a polymer.

Exposing a first portion may include disposing a first mask over the coated surface and exposing the coated surface to the radiation through the first mask, wherein portions of the coated surface other than the first portion of the coated surface are shadowed by the first mask. Exposing a first portion may further include aligning the first mask in a predetermined position with respect to the coated surface, and the method may further include depositing a first material over the coated surface, aligning a second mask in a predetermined position with respect to the position of the first mask, exposing the coated surface to the radiation through the second mask, rinsing the substrate in the aqueous solution to remove a second portion of the photoresist, and depositing a second material over the coated surface.

In another aspect, the invention is method of patterning a material. The method includes providing a substrate having an electropositive surface, depositing a photoresist having a photocleavable group over the electropositive surface to coat the substrate with the photoresist, exposing a first portion of the coated substrate to radiation at a wavelength and for a time sufficient to photocleave the photocleavable group, and rinsing the substrate in an aqueous solution in which the photocleaved portion of the photoresist is substantially less soluble than the unexposed photoresist, thereby causing the photoresist to form a patterned surface.

### BRIEF DESCRIPTION OF THE DRAWING

The invention is described with reference to the several figures of the drawing, in which,

FIG. 1 is a schematic of the chemical structure of an exemplary photoresist according to an embodiment of the invention and a mechanism for in situ polyelectrolyte bilayer formation

FIG. 2A is a schematic showing a streptavidin-conjugated quantum dot.

FIG. 2B is a fluorescence micrograph of quantum dots patterned on a substrate.

FIG. 3B is a graph illustrating UV exposure time vs. remaining photoresist film thickness for the photoresist depicted in FIG. 1A.

FIG. 3C is an image of the photoresist depicted in FIG. 1A after UV-exposure, development, and methylene blue-staining.

FIG. 3D is a graph illustrating the pH-dependent solubility of the UV-exposed photoresist of FIG. 1A.

FIG. 4 is a schematic showing the reactions leading to biotinylation of hydroxyl termini of PEGMA.

FIG. 5 is a schematic illustrating an exemplary procedure of dual streptavidin patterning.

FIG. 6 is a set of fluorescent micrographs of a dual-streptavidin patterned surface. (A) SAv-TR fluorescence, (B) SAv-FITC fluorescence, (C) overlay. Scale bar in each image is 20 μm.

FIGS. 7A and B are schematics of (A) specific and (B) non-specific binding of streptavadin to a photoresist according to an embodiment of the invention.

FIGS. 7C and D are fluorescence images illustrating substrates prepared according to an embodiment of the invention to which streptavadin is (C) specifically and (D) non-specifically bound and graphs of the fluorescence intensity of each image.

### DETAILED DESCRIPTION OF CERTAIN PREFERRED EMBODIMENTS

In one embodiment, a terpolymer of a hydrophobic monomer, a hydrophilic monomer, and a monomer having a sidegroup that is photocleavable to produce a carboxyl side chain is employed as a photoresist. The photoresist may be soluble in aqueous solutions at or near physiological pH but not at a different predetermined pH. The photoresist may be deposited on an electrolyte-coated substrate. Exposure to UV through a mask may render the exposed portions soluble in aqueous solutions at physiological pH. Rinsing the photoresist coated substrate, for example, in phosphate buffered saline, creates a pattern of the photoresist that corresponds to that of the mask.

An exemplary terpolymer is a random co-polymer of methyl methacrylate (MMA), poly(ethylene glycol) methacrylate (PEGMA), and o-nitrobenzyl methacrylate (ONBMA). The ratios of the three co-monomers may be adjusted to manipulate the solubility of the polymer and also whether the polymer serves as a positive or negative resist. In general, sufficient ONBMA may be present to create sufficient carboxylic acid groups after UV exposure to promote solubility. The amount of ONBMA may be at least 30%, at least 35%, at least 40%, at least 45%, or at least 50%. The amount of PEGMA may be adjusted to provide sufficient hydrophilicity that the photoresist does not dewet from the substrate while not dissolving prematurely in aqueous buffers and to prevent excessive hydrogen bonding between the PEGMA and the photogenerated carboxylic acid. The amount of PEGMA will partially depend on the amount of ONBMA and may be 30% or less, 25% or less, 20% or less, 15% or less, or 10% or less. The amount of MMA may be adjusted to provide sufficient hydrophobicity to prevent premature dissolution while not being so great that the photoresist dewets from the substrate. The amount of MMA may be at least at least 30%, at least 35%, at least 40%, at least 45%, or at least 50%. The PEGMA units also serve as a barrier to nonspecific protein binding to the photoresist.

One skilled in the art will recognize that the composition of the co-monomers may also be varied. Monomers may be substituted for any of MMA, PEGMA, or ONBMA. In general, monomers may be chosen that do not absorb significantly at the wavelength used for cleavage of the photoreactive group. For example, upon UV exposure, the ONBMA is cleaved to a pH sensitive carboxylic acid.^{17,18} The compositions of the monomers may be varied using the same considerations (e.g., balancing hydrophobicity and hydrophilicity, minimizing hydrogen bonding, etc.) as described above for the relative ratios of the co-monomers. Exemplary monomers that may be substituted for MMA include ethyl methacrylate, n-butyl methacrylate, n-decyl methacrylate, 2-ethylhexyl methacrylate, N-(n-octadecyl)acrylamide, n-tert-octylacrylamide, stearyl acrylate, stearyl methacrylate, and vinyl stearate. Exemplary monomers that may be substituted for the PEGMA include hydroxyethylmethacrylate, hydroxyethyl acrylate, 4-hydroxybutyl methacrylate, N-(2-hydroxypropyl)methacrylamide, n-methylmethacrylamide, acrylamide, poly(ethylene glycol) monomethyl ether methacrylates, poly(ethylene glycol) methacrylates, and n-vinyl-2-pyrrolidone. The PEG chain on PEGMA may have 6 mers. More or fewer mers may be employed as well, for example, 3-9 mers. A longer PEG chain will increase hydrogen bonding and vice versa.

Alternative photocleavable groups of the general structure 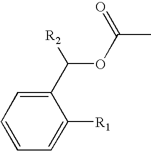
that leave behind a carboxyl group after photocleavage may also be substituted for the o-nitrobenzyl group on the ONBMA. For example, the position R₂ may be substituted with benzoyl, hydrogen, benzyl, alkyl, alkenyl, aryl, or cycloalkyl. Three groups may in turn be substituted, for example, with benzoyl, benzyl, alkyl, alkenyl, aryl, or cycloalkyl. Alternatively, or in addition, R₁ may be hydrogen or nitro. In one embodiment, benzoin (R₁═H, R₂=benzoyl), which is photocleavable at 350 nm, is employed. Alternatively or in addition, photocleavage may occur after exposure to about 1350 mJ/cm² to about 2025 mJ/cm² or more of UV radiation. One skilled in the art will recognize that the energy required for photocleavage may depend on a variety of factors, including film composition and thickness. The required energy for a particular film may be determined by “titrating” the film with various amounts of energy.

In one embodiment, the relative stabilities of the various monomer radicals are sufficiently close that the co-monomers are incorporated into the polymer essentially randomly.

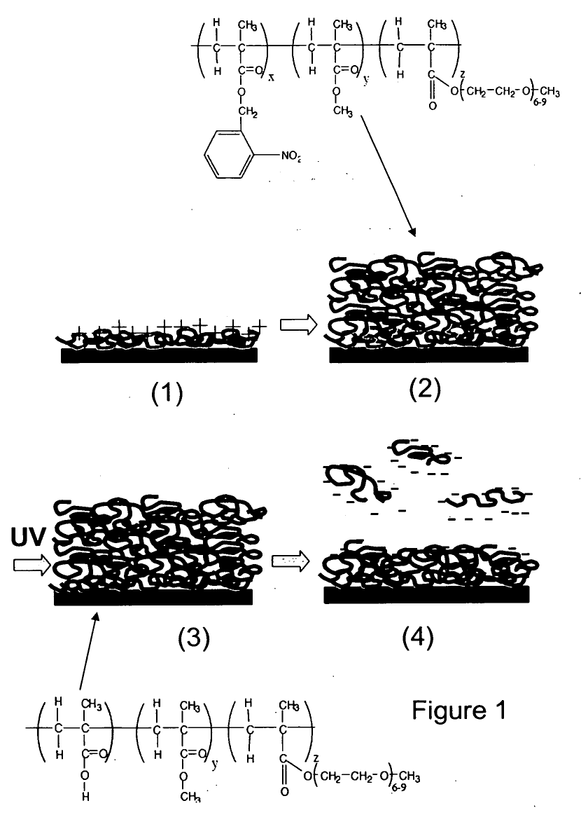

In one embodiment, the photoresist polymer is deposited on a polyelectrolyte substrate (FIG. 1, Schemes 1 and 2). Of course, the substrate may be a metal, ceramic, semiconductor, or polymer substrate coated with the polyelectrolyte. For example, the substrate may be glass, mica, silicon, or polystyrene. Exemplary polyelectrolytes for use in coating the substrate include poly(allylamine)hydrochloride (PAH), polylysine, poly(ethyleneimine), poly(diethylaminoethyl methacrylate), poly(2-aminoethyl methacrylate), and chitosan. Such materials may be coated by adsorption, spin coating, dip coating, solvent casting, roll casting, or other methods known to those skilled in the art. The polymer may be deposited by dip coating, spin coating, or any other technique known to those skilled in the art. The photoresist may be deposited to a thickness of about 200 nm or more. One skilled in the art will recognize that thicker films may be employed, but that it may require longer exposure times or higher energy exposures to pattern the film.

In another embodiment, the substrate is functionalized with an amine-terminated self-assembled monolayer (SAM). For example, aminosilanes may be used to aminate the surface of a silicon or silica substrate. Any anchor group that is used to anchor a SAM may be used to retain an amine or other electropositive or positively charged group on the substrate for use with the invention. For example, organosilanes may be deposited on silicon, glass, fused silica, or any substrate with an oxidized surface, for example, silica, alumina, calcium phosphate ceramics, and hydroxylated polymers. Carboxylic acids may also be used as anchors to oxidized substrates such as silica, alumina, quartz, glass, and other oxidized surfaces, including oxidized polymeric surfaces. Metals such as gold, silver, copper, cadmium, zinc, palladium, platinum, mercury, lead, iron, chromium, manganese, tungsten, and alloys of these may be patterned by forming thiol, sulfide, and disulfide bonds with molecules having sulfur-containing anchor groups. In addition, molecules may be attached to aluminum substrates via a phosphonic acid (PO₃²⁻) anchor. Nitriles and isonitriles may be used to attach molecules to platinum and palladium, and copper and aluminum may be coated with a SAM via a hydroxamic acid. Other functional groups available suitable for use as anchors include acid chlorides, anhydrides, sulfonyl groups, phosphoryl and phosphonic groups, hydroxyl groups, and amino acid groups.

Of course, SAMs may be deposited on semiconductor materials such as germanium, gallium, arsenic, and gallium arsenide. Substrates, including metals, ceramics, polymers, and semiconductors, need not be coated with an electrolyte if their surfaces already carry an appropriate charge. Unoxidized polymeric materials, especially those having electron-rich elements in their backbones or side chains, may also be used as substrates. Exemplary materials include epoxy compounds, polysulfones, acrylonitrile-butadiene-styrene copolymers, and biodegradable polymers such as polyanhydrides, polylactic acid, polyglycolic acid, and copolymers of these materials. Materials may be oxidized by plasma etching to render them suitable for coating with a silane or carboxylate-anchored SAM.

Once the photoresist is deposited on the substrate, it may be exposed to photocleaving radiation through a mask (FIG. 1, Scheme 3, mask not shown). In one embodiment, the radiation has a wavelength in the ultraviolet range. Photolysis of the polymers described herein increases the solubility of the polymer in aqueous media, for example, by creating carboxyl groups on the photoresist. These carboxyl groups increase the solubility of the polymer at certain pH. For example, photocleaved ONBMA terpolymer is soluble in pH 7.4 phosphate buffered saline (PBS) but not in pH 6 solutions. The exposed photoresist may be “developed” by rinsing it in a solution in which the photocleaved polymer is soluble (FIG. 1, Scheme 4). The majority of the exposed photoresist dissolves into the solution. However, ellipsometry measurements indicate that the developed portions are thicker than the original electrolyte coating. Without being bound by any particular theory, we hypothesize that the increased thickness results from formation of a electrolyte bilayer at the photoresist/PAH interface by electrostatic cross-linking of newly formed carboxylic acid groups to amines in the electrolyte during UV exposure.

In an alternative embodiment, the photoresist is used as a negative resist. For example, the relative proportions of the photocleavable co-monomer and the hydrophilic monomer may be adjusted to promote hydrogen bonding after photolysis. The hydrogen bonding renders the exposed polymer more resistant to dissolution. Immersion of the photoresist in a solution in which the non-exposed portions of the photoresist are soluble will result in a negative pattern on the substrate.

A variety of materials, especially biological materials, may be patterned on the substrate. Proteins and other electrolyte materials will deposit non-specifically on the developed and non-developed portions of the substrate. However, when the substrate is rinsed in the proper solution, the exposed photoresist will wash off the substrate along with any material adsorbed to it, leaving behind the deposited material in the pattern established by the mask. If desired, a second material may be patterned on the newly exposed substrate surface. Thus, two materials may be co-patterned on a surface without exposing either of them to UV radiation.

After the photoresist is developed to define a pattern, it may be exposed again to prime the ‘background’ of the resist for removal. However, in some embodiments, it may be desirable to pattern more than one material on the surface. For example, standard photolithographic techniques may be used to align a second mask over an exposed substrate on which a first material has been deposited. The newly exposed photoresist is washed away upon rinsing with the proper solution. In one embodiment, the first deposited material is stable at the pH of the rinsing solution. The second material, for example, a second protein, may be co-patterned with the first.

In another embodiment, the originally deposited material is stable with respect to UV exposure at the wavelength and exposure times required to dissociate the photocleavable group. The second mask need not shield the originally patterned material from radiation.

The limits of the resolution of this technique are partially determined by the limits of the mask and other factors common to traditional photolithography techniques. The deposited patterns may have a resolution of 1 micron or less. Resolutions of 100 nm are also achievable using the techniques described herein (see Menon, R., et al., Journal of Vacuum Science and Technology B, (2004) 22(6):3032-3037, the entire contents of which are incorporated herein by reference). One skilled in the art will recognize that the pattern may have practically any two-dimensional layout. The mask may or may not have regions that exhibit varying types of symmetry, and the length and width scale of the features of the mask may vary.

Proteins and other biomolecules may be immobilized on the substrate using a variety of techniques. The materials being immobilized may be stable at a pH where the exposed photoresist is relatively insoluble. In one embodiment, the interaction between streptavadin and biotin may be used as a link to attach proteins to the substrate. The PEGMA mers of the photoresist may be biotinylated after polymerization. After exposure and development of the photoresist, some of the photoresist polymer remains as part of an electrolyte bilayer on the substrate surface, leaving a biotinylated surface. Streptavadin is then deposited on the surface, followed by a biotinylated protein. Many proteins are available already derivatized with biotin, others may be readily prepared using recombinant DNA technology (see, Altman J D, et al., Science 274: 94-96, 1996, the contents of which are incorporated by reference herein). The proteins are thus specifically deposited on the substrate through the interaction between streptavadin and biotin. Other biotinylated materials, such as nucleic acids, e.g., polymers of at least two nucleotides, may also be deposited in this manner.

This technique can be used to bind multiple proteins or other materials to the surface. Commercially biotinylated proteins are often multiply biotinylated. These sites remaining after the protein is retained on the surface may be blocked with streptavadin. A biotin blockade (exposure to the surface to an excess of biotin) will block the remaining streptavadin sites on the surface, after which another section of the photoresist may be developed and patterned with a second biotinylated material.

In another embodiment, biomolecules are simply adsorbed onto the substrate surface. Biomolecules may be retained on the surface through covalent or non-covalent interactions. Exemplary non-covalent interactions include van der Waals interactions, hydrophobic interactions, hydrogen bonding, electrostatic interactions, and pi-bonding. Pi-bond receptors in the substrate may be chosen to be stable with respect to the irradiating wavelengths used to expose the photoresist. Because direct adsorption of a protein to the substrate is non-specific with respect to the location on the protein that interacts with the substrate, the activity of adsorbed proteins may be reduced with respect to proteins retained through a biotin-streptavadin link.

In another embodiment, proteins A and G are used to pattern antibodies on the substrate. Proteins A and G bind the Fc region of IgG antibodies. These proteins may be patterned on the surface using the biotin-streptavadin link described above, followed by deposition of the desired antibody.

In a further embodiment, the photoresist may be carboxylated. For example, the ends of the PEG moieties on the PEGMA mers may be carboxylated. Carbodiimide chemistry using EDC (1-ethyl-3-(3-dimethylaminopropyl)-carbodiimide) may be used to link aminated proteins (e.g., proteins having amino acids with aminated side groups) or other materials to the PEG moieties remaining in electrolyte bilayers on the substrate after the photoresist is developed.

In another embodiment, the material that is patterned on the substrate is retained by host-guest interactions. For example, a macrocyclic host, such as cucurbituril or cyclodextrin, may be attached to the photoresist, and a guest group, such as an alkyl group, a polyethylene glycol, or a diaminoalkyl group, may be attached to the material being deposited, or vice versa. In one embodiment, the host and/or the guest molecule may be attached to the agent or the polymer via a linker, such as an alkylene linker or a polyether linker.

A variety of biomolecules and biological materials may be patterned on the substrate surface using the techniques described herein. The term “biomolecules”, as used herein, refers to molecules (e.g., proteins, amino acids, peptides, polynucleotides, nucleotides, carbohydrates, sugars, lipids, nucleoproteins, glycoproteins, lipoproteins, steroids, etc.) whether naturally-occurring or artificially created (e.g., by synthetic or recombinant methods) that are commonly found in cells and tissues. Specific classes of biomolecules include, but are not limited to, enzymes, receptors, neurotransmitters, hormones, cytokines, cell response modifiers such as growth factors and chemotactic factors, antibodies, vaccines, haptens, toxins, interferons, ribozymes, anti-sense agents, plasmids, DNA, and RNA.

In one embodiment, proteins may be patterned as described above. Proteins that are not stable with respect to UV radiation, such as cytokines, histocompatibility proteins and other proteins including multiple chains held together by non-covalent bonds, may particularly benefit from the teachings herein. More stable proteins, such as antibodies, may also be patterned using the teachings herein. Other biomolecules, such as DNA, RNA, and polysaccharides, may also be patterned as described herein. Of course, biomolecules that are more stable with respect to UV exposure may also be patterned using the techniques described herein. Indeed, these biomolecules are particularly suited to being the first or second materials deposited on a substrate on which a series of materials are being patterned, for example, where they will be exposed to UV radiation as successive portions of the photoresist are exposed and developed. Cells may also be patterned using the techniques of the invention. For example, binding peptides for different cells may be patterned on different parts of the substrate, which may then be used to detect particular cells.

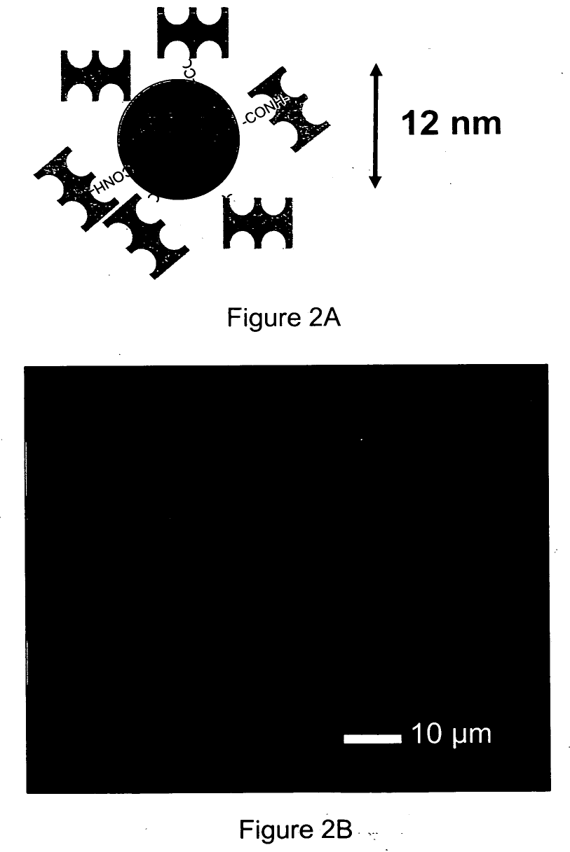

In another embodiment, quantum dots and other nanoparticles may be patterned on the surface. Nanoparticles of metals, semiconductors, or ceramics for use with the invention may be purchased or produced using any technique familiar to those skilled in the art. For example, U.S. Pat. No. 6,576,291, the contents of which are incorporated herein by reference, discloses a method of producing a semiconductor nanocrystallite. The reaction conditions may be altered to control the size of the final product. Other methods that may be used to produce nanoparticles and quantum dots include those described in U.S. Pat. Nos. 6,207,229, 6,319,426, 6,322,901, 6,426,513, 6,607,829, 5,505,928, 5,537,000, 6,225,198, 6,306,736, 6,440,213, 6,743,406, and 6,649,138, the contents of all of which are incorporated by reference. In one embodiment, streptavidin-conjugated quantum dots (commercially available from Quantum Dot, Inc.) may be patterned on a surface using techniques similar to those described above for biologically active materials (FIG. 2).

Nanoparticles may be produced or purchased with a variety of coatings to manipulate their interaction with one another and with a particular substrate. For example, some nanoparticle synthesis methods result in the production of an organic coating coordinated with the surface atoms of the nanoparticles. The surface may be modified by repeated exposure to an excess of a competing coordinating group. Such a surface exchange process may be carried out using a variety of compounds which are capable of coordinating or bonding to the outer surface of the nanoparticle, such as by way of example, phosphines, thiols, amines, silanes and phosphates. In other embodiments, the nanoparticles may be exposed to short chained polymers which exhibit an affinity for the capped surface on one end and which terminate in a moiety having an affinity for the substrate surface.

### EXAMPLES

### Example 1

### Preparation of a Photoresist

To obtain a photoresist which could be processed using biological buffers, a random terpolymer was synthesized by free radical polymerization of o-nitrobenzyl methacrylate (o-NBMA) with methyl methacrylate (MMA) and poly(ethylene glycol) methacrylate (PEGMA).

O-nitrobenzyl methacrylate was prepared by reacting 2-nitrobenzyl alcohol (8.42 g) with methacryloyl chloride (4.84 ml, Lancaster Synthesis) in the presence of triethylamine (7.68 ml) in dichloromethane (DCM) at 0° C. for 12 hours. The mixture was filtered and the solvent evaporated. The crude mixture was purified by silica gel chromatography with 6:1 hexane/ethyl acetate. ₁H NMR (Varian 300 MHz, CDCl₃): δ 1.99 (s, 3H), δ 5.60 (s, 2H), δ 5.65 (s, H), δ 6.2 (s, H), δ 7.62 (m, 3H), δ 8.10 (d, H).

The photoresist was synthesized by free radical polymerization of methyl methacrylate (6.3 ml), o-nitrobenzyl methacrylate (6.2 ml), and poly(ethylene glycol) methacrylate (PEGMA, 2.9 ml, Mn˜360) in 400 ml ethyl acetate at 70° C. for 18 hours, initiated by 0.4 g of 2,2′-Azobis(2-methylpropionitrile). The reaction was terminated by addition of 40 mg of 4-methoxyphenol. The resulting copolymer was purified by two precipitations in diethyl ether and dried in vacuo at 25° C. for 24 hours. Chemical composition was analyzed by ₁H NMR in DMSO (o-NBMA˜43 wt %, MMA˜35 wt %, PEGMA˜22 wt %); molecular weight (M_{n˜}9,600 relative to PMMA standards) and polydispersity index (1.83) were determined by gel permeation chromatography (Viscotek GPCmax system with two G4000 HR columns and one G5000 HR column).

At a composition of o-NBMA˜43 wt %, MMA˜38 wt %, and PEGMA˜19 wt %, thin films of the terpolymer could be dissolved by phosphate buffered saline (pH 7.4 PBS, 10 nmM sodium phosphate, 140 mM sodium chloride) after brief exposure to UV irradiation.

### Example 2

### Preparation and Patterning of Photoresist Layer on a Substrate

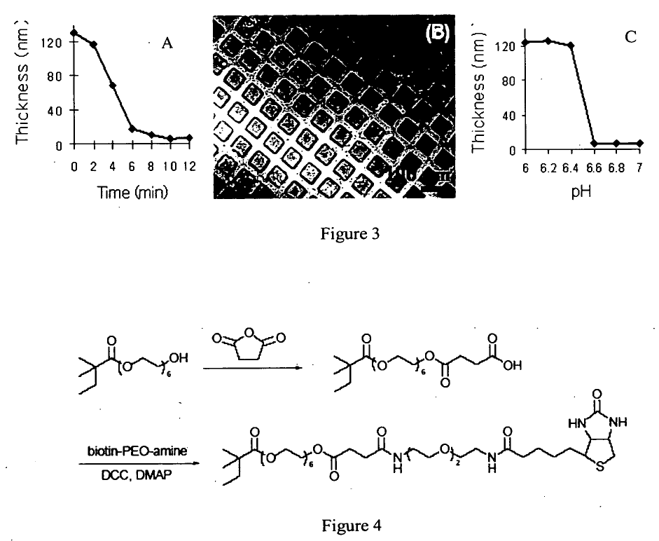

Poly(allylamine) hydrochloride (PAH, Mw˜70,000) was adsorbed on glass coverslips or silicon substrates (dry thickness 3 nm), and a 130 nm thick film of photoresist polymer was subsequently spin-coated over the polycation monolayer. Photoresist films were then exposed under a UV lamp (254 nm, 2.25 mW/cm²) for various times and rinsed with PBS for 1 minute. The thickness of dried films (measured by ellipsometry) after UV exposures of ≧10 min was 6-10 nm, indicating dissolution of the majority of the polymer but retention of a layer significantly thicker than the initial PAH film (FIG. 3A). We hypothesized that this remaining film was a polyelectrolyte bilayer formed in situ at the photoresist/PAH interface by electrostatic cross-linking of newly-formed carboxylic acid groups to amines on the PAH during WV exposure. To test this hypothesis, photoresist-coated substrates were WV-exposed for 15 minutes through a TEM grid as a crude photomask, rinsed with PBS, then dipped in a solution of cationic methylene blue dye. Only UV-exposed regions were stained (FIG. 3B), suggesting that a polyelectrolyte bilayer with a net negative surface charge had formed between photogenerated polyanions and the underlying polycation.

The degree of ionization of weak polyelectrolytes is sensitive to pH, and thus the stability of a polyelectrolyte film in aqueous buffers can likewise exhibit pH dependence.^{19,20} Protonation of the carboxylic acid groups on our UV-exposed photoresist at reduced pH made the polymer insoluble in acidic aqueous buffers. As shown in FIG. 1D, photoresist-coated substrates exposed to UV for 15 min followed by rinsing with phosphate buffer (10 mM sodium phosphate) for 1 minute exhibited dramatically different final thicknesses depending on the pH of the buffer solution. At low pHs, the UV-exposed films were stable in phosphate buffer. However, at a pH≧6.6, UV-exposed films dissolved to a constant thickness (6˜10 nm) consistent with the hypothesized polyelectrolyte bilayer structure.

### Example 3

### Biotinylation of Photoresist Polymer

Hydroxyl termini of PEGMA units in the photoresist were carboxylated for further functionalization (FIG. 4). Briefly, the photoresist polymer (9 g) and succinic anhydride (5.52 g) were added to a three-neck flask with condenser, and 250 ml anhydrous dichloroethane was cannulated. The photoresist polymer was observed to quickly dissolve while the succinic anhydride remained suspended in the solvent. The mixture was degassed 15 minutes by bubbling nitrogen, then N-methylimidazole (Aldrich, 72 μl) was added dropwise with stirring. The reaction was carried out for 15 hours at 65° C. The carboxylated photoresist was purified by sequential precipitations in diethyl ether and 5 vol % aqueous HCl. The polymer was washed 18 hours by stirring in 5 vol % aqueous HCl, recovered by filtration, and dried at 60° C. in vacuo. The carboxylated photoresist polymer was biotinylated by coupling amine-PEO-biotin (3 ethylene glycol repeats, Pierce Biotechnology) to the carboxylic acid groups of the modified photoresist terpolymer. Carboxylated photoresist (2 g), biotin-PEO-amine (30 mg), 4-dimethylaminopyridine (DMAP, 8 mg) and DCM (19 ml) were added to a round-bottom flask. N,N′-Dicyclohexylcarbodiimide (DCC, 20 mg) was dissolved in 1 ml of DCM and immediately added dropwise to the reaction mixture while stirring. The reaction mixture was stirred for 18 hours at room temperature, and the resulting biotinylated polymer was recovered by precipitation in diethyl ether.

Biotinylation was confirmed by detecting specific binding of fluorescein isothiocyanate (FITC)-labeled streptavidin to thin films of the functionalized photoresist. Biotinylated or non-biotinylated (carboxylated) photoresist films were prepared by spincoating on glass coverslips. Each substrate was incubated in streptavindin-FITC S4 solution (5 μg/ml in PBS) for 30 min, followed by rinsing with water. Bound streptavidin-FITC was detected on each surface by measuring fluorescence intensity using a Zeiss epifluorescence microscope equipped with a Roper Scientific CoolSnap HQ CCD camera. The ratio of background-corrected fluorescence from films of biotinylated film PR to nonbiotinylated PR was ˜60.

### Example 4

### Deposition of Fluorophores Using Streptavadin

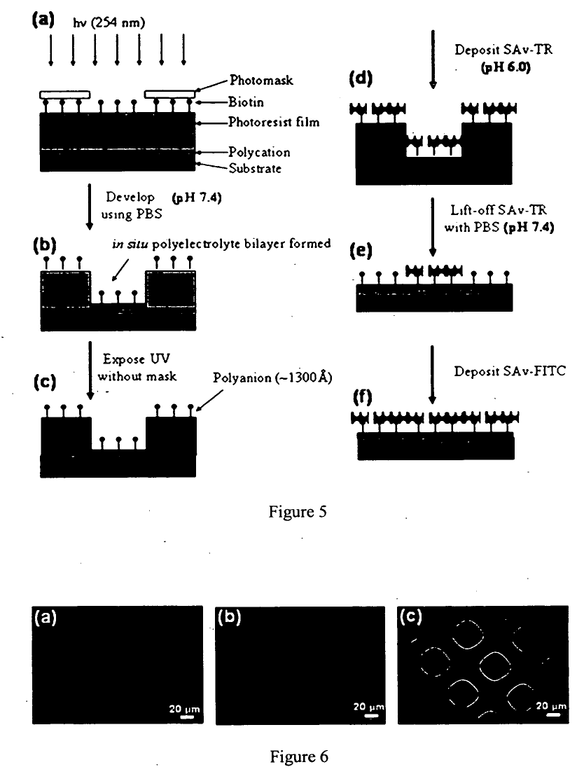

Using a biotinylated photoresist, assembly of two different fluorophore-coupled proteins (Texas-Red-conjugated streptavidin (SAv-TR) and fluorescein isothiocyanate-conjugated streptavidin (SAv-FITC)) was achieved following the scheme shown in FIG. 5. A photoresist film spincoated atop a PAH monolayer was exposed to UV through a photomask (FIG. 5A), and developed with PBS rinsing (FIG. 5B). Next, the substrate was re-exposed to UV without a photomask (FIG. 5C), and streptavidin Texas-Red (SAv-TR) in pH 6.0 PBS was adsorbed (FIG. 5D). Since the UV-exposed photoresist is not soluble in pH 6.0 PBS, the thick film of UV-exposed photoresist remained intact during this step, and SAv-TR bound to the entire surface (Data not shown). By subsequently washing the surface with pH 7.4 PBS, the thick photoresist film masking the ‘background’ was dissolved, removing SAv-TR on that region and exposing underlying biotin groups in the retained polyelectrolyte bilayer for ‘backfilling’ with a second type of SAv (FIG. 5E). SAv-FITC was adsorbed on the newly exposed region (FIG. 5F).

Fluorescence micrographs of typical surfaces prepared by this process are shown in FIG. 6. FIG. 6A and FIG. 6B were taken from the same surface with excitation/emission filters matching Texas-Red and FITC, respectively; FIG. 6C shows an overlay of the two images. The red and green-channel images show the clear segregation of the two proteins to their respective target regions with high fidelity. In this process, the patterning steps including proteins were performed with the samples immersed in aqueous buffers under mild conditions (pH 6.0-7.4 solutions, no UV exposure, no dehydration or heating), which will preserve the activity of proteins with fragile non-covalent structures.

### Example 5

### Characterization of Protein Patterned Surfaces

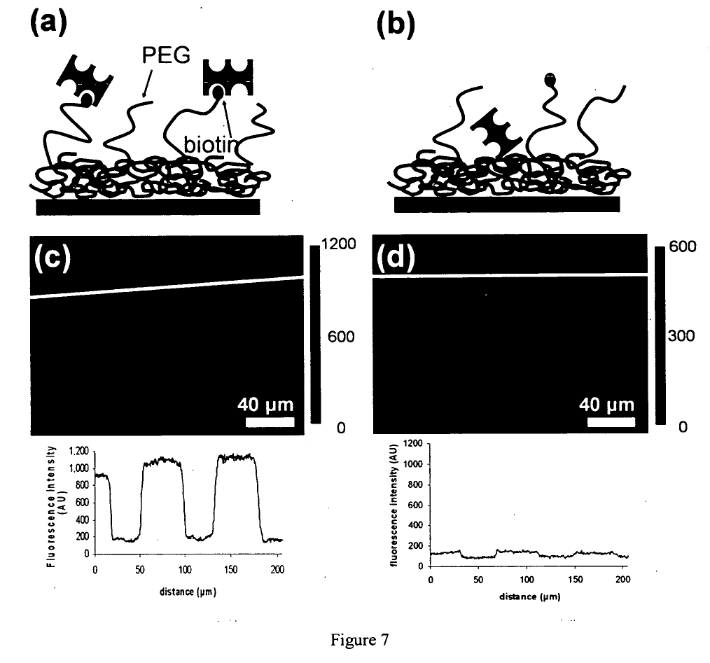

In any protein immobilization strategy, protein may bind to a surface by both specific mechanisms (i.e., designed covalent bounding or ligand-receptor binding) and nonspecific mechanisms (e.g., by uncontrolled hydrophobic/van der Waals associations, hydrogen bonding, or ionic bonding to the surface). For the present photoresist system, these avenues of protein binding are schematically illustrated in FIG. 7: streptavidin may be specifically bound to surfaces by the high affinity binding of the protein to biotin groups presented at the ends of PEG tethers of the photoresist (FIG. 7A) or may nonspecifically adsorb directly to the various chemical moieties available at the photoresist surface (FIG. 7B). To measure the relative amounts of specific and non-specific protein bound to patterned biotinylated PR films, we quantified the fluorescence from Texas-Red-labeled streptavidin (SAv-TR, Molecular Probes) immobilized on patterned surfaces. Biotinylated PR films on PAH-coated glass coverslip substrates were exposed with a grid pattern as illustrated in FIG. 5A-C. Labeled streptavidin (0.2 μM in PBS pH 6.0) was then incubated 30 min over patterned surfaces prepared as in FIG. 5D, and the ‘background’ of the pattern was cleared by lift-off using pH 7.4 PBS (FIG. 5E). To measure nonspecific binding, surfaces were alternatively immersed in 0.2 μM solutions of SAv-TR (in PBS pH 6.0) that had been pre-incubated with 200 μM biotin-PEO-amine for 1 hour on ice to block its biotin-binding pockets. Samples were then imaged on a Zeiss Axiovert 200 epifluorescence microscope equipped with a Roper Scientific CoolSnap HQ CCD camera and 40× oil immersion objective (NA 1.3). The resulting fluorescence micrographs for surfaces incubated with SAv-TR or blocked SAv-TR are shown in FIGS. 7C and D, respectively. Background fluorescence was measured on each sample prior to incubation with streptavidin. The amount of non-specific binding was estimated by comparing the background-corrected average fluroescence intensity of surfaces exposed to blocked or unblocked streptavidin. The fluorescence intensity from blocked SAv-TR surfaces was only 6.6±3.0% of the fluorescence intensity from surfaces patterned with the unblocked protein. In addition to reducing nonspecific protein binding, ligands tethered by PEG linkers are biologically much more active than physically adsorbed ligands (Kuhl, P. R.; Griffth-Cima, L. G. Nature Medicine 1996, 2, 1022-1027). due to the dynamic nature of the PEG linker in solution and the reduced possibility of denaturation by direct physical contact with the underlying surface.

Protein binding to the dual-patterned surface shown in FIG. 6 was also analyzed using fluorescence intensity measurements. The fluorescence contrast of protein (average ratio of the background-corrected fluorescence intensity from the protein-bearing regions to the intensity from the ‘clear’ regions) in the first region (SAv-TR shown in FIG. 6A and the overlay FIG. 6C) was 5.74±0.74, while that of protein patterned into the second region (SAv-FITC, FIGS. 5B and 5C) was 4.82±1.10. These measured contrasts compare well with other quantitative reports of patterning single proteins on glass¹³ or silicon⁵. The similar values of contrast measured for the first protein (patterned by a lift-off step which makes any cross-contamination of the protein outside its target region unlikely) and the second protein suggests that the degree of cross-contamination is small.

### References

1) Blawas, A. S.; Reichert, W. M. Biomaterials 1998, 19, 595.
2) Folch, A.; Toner, M. Annu. Rev. Biomed. Eng. 2000, 2, 227.
3) Whitesides, G. M.; Ostuni, E.; Takayama, S.; Jiang, X. Y.; Ingber, D. E. Annu. Rev. Biomed. Eng. 2001, 3, 335.
4) Ito, Y. Biomaterials 1999, 20, 2333.
5) Orth, R. N.; Clark, T. G.; Craighead, H. G. Biomedical Microdevices 2003, 5, 29.
6) Flounders, A. W.; Brandon, D. L.; Bates, A. H. Biosens. Bioelectron. 1997, 12, 447.
7) Nicolau, D. V.; Taguchi, T.; Taniguchi, H.; Yoshikawa, S. Langmuir 1998, 14, 1927.
8) Bernard, A.; Renault, J. P.; Michel, B.; Bosshard, H. R.; Delamarche, E. Adv. Mater. 2000, 12, 1067.
9) Yang, Z. P.; Chilkoti, A. Adv. Mater. 2000, 12, 413.
10) Willner, I.; Katz, E. Angew. Chem.-Int. Edit. 2000, 39, 1180.
11) Lee, K. B.; Park, S. J.; Mirkin, C. A.; Smith, J. C.; Mrksich, M. Science 2002, 295, 1702.
12) Holden, M. A.; Cremer, P. S. J. Am. Chem. Soc. 2003, 125, 8074.
13) Blawas, A. S.; Oliver, T. F.; Pirrung, M. C.; Reichert, W. M. Langmuir 1998, 14, 4243.
14) Lee, K. B.; Lim, J. H.; Mirkin, C. A. J. Am. Chem. Soc. 2003, 125, 5588.
15) Tien, J.; Nelson, C. M.; Chen, C. S. Proc. Natl. Acad. Sci. U.S.A. 2002, 99, 1758.
16) Sorribas, H.; Padeste, C.; Tiefenauer, L. Biomaterials 2002, 23, 893.
17) Barzynski, H.; Sanger, D. Angew. Makromol. Chem. 1981, 93, 131-141.
18) Schwalm, R. J. Electrochem. Soc. 1989, 136, 3471-3476.
19) Sukhishvili, S. A.; Granick, S. J. Am. Chem. Soc. 2000, 122, 9550-9551.
20) Yang, S. Y.; Rubner, M. F. J. Am. Chem. Soc. 2002, 124, 2100-2101.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A photoresist material, comprising a terpolymer of methyl methacrylate, poly(ethylene glycol) methacrylate, and o-nitrobenzyl methacrylate.

2. A photoresist material, comprising a photocleavable polymer, wherein the photocleaved polymer is substantially less soluble in aqueous solutions at pH 6 and below than in aqueous solutions having a pH greater than 6.

3. The photoresist material of claim 2, wherein the photocleaved polymer is soluble in aqueous solutions having a pH of 6.5 or greater.

4. A photoresist material, comprising a terpolymer of a hydrophobic monomer, a hydrophilic monomer, and a monomer having a sidegroup of 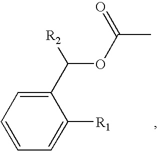
wherein R₁ is H or NO₂, and wherein R₂ is selected from benzyl, benzoyl, alkyl, alkenyl, hydrogen, aryl, and cycloalkyl.

5. The photoresist material of claim 4, wherein at least 30% of the mers of the terpolymer correspond to the hydrophobic monomer.

6. The photoresist material of claim 4, wherein at least 35% of the mers of the terpolymer correspond to the hydrophobic monomer.

7. The photoresist material of claim 4, wherein at least 40% of the mers of the terpolymer correspond to the hydrophobic monomer.

8. The photoresist material of claim 4, wherein at least 45% of the mers of the terpolymer correspond to the hydrophobic monomer.

9. The photoresist material of claim 4, wherein at least 50% of the mers of the terpolymer correspond to the hydrophobic monomer.

10. The photoresist material of claim 4, wherein at most 30% of the mers of the terpolymer correspond to the hydrophilic monomer.

11. The photoresist material of claim 4, wherein at most 25% of the mers of the terpolymer correspond to the hydrophilic monomer.

12. The photoresist material of claim 4, wherein at most 20% of the mers of the terpolymer correspond to the hydrophilic monomer.

13. The photoresist material of claim 4, wherein at most 15% of the mers of the terpolymer correspond to the hydrophilic monomer.

14. The photoresist material of claim 4, wherein at most 10% of the mers of the terpolymer correspond to the hydrophilic monomer.

15. The photoresist material of claim 4, wherein the monomer having a sidegroup is photocleavable to a carboxyl group.

16. The photoresist material of claim 4, wherein the hydrophobic monomer is selected from methyl methacrylate, ethyl methacrylate, n-butyl methacrylate, n-decyl methacrylate, 2-ethylhexyl methacrylate, N-(n-octadecyl)acrylamide, n-tert-octylacrylamide, stearyl acrylate, stearyl methacrylate, and vinyl stearate.

17. The photoresist material of claim 4, wherein the hydrophilic monomer is selected from hydroxyethylmethacrylate, hydroxyethyl acrylate, 4-hydroxybutyl methacrylate, N-(2-hydroxypropyl)methacrylamide, n-methylmethacrylamide, acrylamide, poly(ethylene glycol) monomethyl ether methacrylates, poly(ethylene glycol) methacrylate, poly(ethylene glycol) methacrylates, and n-vinyl-2-pyrrolidone.

18. The photoresist material of claim 17, wherein the poly(ethylene glycol) chain is 3-9 mers long.

19. The photoresist material of claim 17, wherein the poly(ethylene glycol) chain is 6 mers long.

20. The photoresist material of claim 4, wherein the monomer having the sidegroup experiences photocleavage upon exposure to at least about 1350 mJ/cm² of UV radiation.

21. The photoresist material of claim 4, wherein the monomer having the sidegroup experiences photocleavage upon exposure to at least about 2025 mJ/cm² of UV radiation.

22. The photoresist material of claim 4, wherein the terpolymer is functionalized with streptavidin, biotin, carboxyl groups, cucurbituril, cyclodextrin, diaminoalkyl groups, alkyl groups, polyethylene glycol, or a macrocyclic host group.

23. A method of patterning a material, comprising:
A) providing a substrate having an electropositive surface;
B) depositing a photoresist having a photocleavable group over the electropositive surface to coat the substrate with the photoresist;
C) exposing a first portion of the coated substrate to radiation at a wavelength and for a time sufficient to photocleave the photocleavable group; and
D) rinsing the substrate in an aqueous solution in which the photocleaved portion of the photoresist is soluble but the unexposed photoresist is substantially less soluble, thereby removing a first portion of the photoresist to form a patterned surface.

24. The method of claim 23, wherein the aqueous solution has a pH between 6 and 8.

25. The method of claim 23, further comprising:
E) exposing a second portion of the coated substrate to radiation at a wavelength and for a time sufficient to photocleave the photocleavable group of the photoresist;
F) depositing the material over the patterned surface; and
G) rinsing the substrate in the solution, whereby a second portion of the photoresist is removed to form a surface on which the material is patterned.

26. The method of claim 25, wherein the second portion of the coated substrate comprises the remaining photoresist coated surface of the substrate.

27. The method of claim 23, wherein the material is a protein, a biomolecule, a nucleic acid, a nanoparticle, or a quantum dot.

28. The method of claim 23, wherein the pattern comprises a feature having at least one in-plane width of 1 micrometer or less.

29. The method of claim 23, wherein the pattern comprises a feature having at least one in-plane width of 0.1 micrometer or less.

30. The method of claim 23, wherein step A) comprises depositing a electrolyte over a surface of the substrate.

31. The method of claim 30, wherein the electrolyte is a polyelectrolyte or a self-assembled monolayer comprising amine-terminated molecules.

32. The method of claim 30, wherein the polyelectrolyte comprises poly(allylamine)hydrochloride (P)AH), polylysine, poly(ethyleneimine), poly(diethylaminoethyl methacrylate), poly(2-aminoethyl methacrylate), or chitosan.

33. The method of claim 23, wherein step C) comprises exposing the first portion to at least about 1350 mJ/cm² of UV radiation.

34. The method of claim 23, wherein step C) comprises exposing the first portion to at least about 2025 mJ/cm² of UV radiation.

35. The method of claim 23, wherein a quantity of photoresist remains on the surface of the substrate following step D).

36. The method of claim 23, wherein the substrate comprises a metal, a ceramic, a semiconductor, or a polymer.

37. The method of claim 23, wherein step C) comprises disposing a first mask over the coated surface and exposing the coated surface to the radiation through the first mask, wherein portions of the coated surface other than the first portion of the coated surface are shadowed by the first mask.

38. The method of claim 37, wherein step C) further comprises aligning the first mask in a predetermined position with respect to the coated surface, and wherein the method further comprises:
E) depositing a first material over the coated surface;
F) aligning a second mask in a predetermined position with respect to the position of the first mask;
G) exposing the coated surface to the radiation through the second mask;
H) rinsing the substrate in the aqueous solution to remove a second portion of the photoresist; and
I) depositing a second material over the coated surface.

39. A method of patterning a material, comprising:
A) providing a substrate having an electropositive surface;
B) depositing a photoresist having a photocleavable group over the electropositive surface to coat the substrate with the photoresist;
C) exposing a first portion of the coated substrate to radiation at a wavelength and for a time sufficient to photocleave the photocleavable group; and
D) rinsing the substrate in an aqueous solution in which the photocleaved portion of the photoresist is less soluble than the unexposed photoresist, thereby causing the photoresist to form a patterned surface.

40. The method of claim 39, wherein the material is a protein, a biomolecule, a nucleic acid, a nanoparticle, or a quantum dot.

41. The method of claim 39, wherein the pattern comprises a feature having at least one in-plane width of 1 micrometer or less.

42. The method of claim 39, wherein the pattern comprises a feature having at least one in-plane width of 0.1 micrometer or less.

43. The method of claim 39, wherein step A) comprises depositing a electrolyte over a surface of the substrate.

44. The method of claim 43, wherein the electrolyte is a polyelectrolyte or a self-assembled monolayer comprising amine-terminated molecules.

45. The method of claim 43, wherein the polyelectrolyte comprises poly(allylamine)hydrochloride (PAH), polylysine, poly(ethyleneimine), poly(diethylaminoethyl methacrylate), poly(2-aminoethyl methacrylate), or chitosan.

46. The method of claim 39, wherein step C) comprises exposing the first portion to at least about 1350 mJ/cm² of UV radiation.

47. The method of claim 39, wherein step C) comprises exposing the first portion to at least about 2025 mJ/cm² of UV radiation.

48. The method of claim 39, wherein the substrate comprises a metal, a ceramic, a semiconductor, or a polymer.
